(19) United States
(12) Patent Application Publication
(10) Pub. No.: US 2007/0050246 A1
(43) Pub. Date: Mar. 1, 2007

(54) Promotional advertising system and method for redeeming promotions using electronic customer credits

(76) Inventor: Paul Talavera, Farmers Branch, TX (US)

Correspondence Address: Holly L. Rudnick, 5401 Lafayette Dr., Frisco, TX, 75035, US

(21) Appl. No.: 11/210,417

(22) Filed: Aug. 24, 2005

(51) Int. Cl. G06Q 30/00

(52) U.S. Cl. 705/14

(57) ABSTRACT

A promotional advertising system that is capable of providing electronic promotions to customers includes a database that maintains promotion information for a business and customer information for a customer. The promotion information identifies one or more promotions offered by the business, and the customer information identifies customer credits for the promotions. In addition, the customer information has a customer identifier associated therewith, which is provided on a promotional card to the customer. The on-line promotional advertising system further includes a web server for accessing the customer information in the database using the customer identifier provided by the customer to the business to determine the available customer credits for the business. The web server further selects one of the customer credits to enable the business to provide a discount to the customer, and deletes the selected customer credit from the customer information.

### BENEFIT CLAIM UNDER 35 U.S.C. §119(e)

This application claims the benefit of U.S. Provisional Application No. 60/______, filed Aug. 27, 2004.

### BACKGROUND OF THE INVENTION

1. Technical Field of the Invention

The present invention relates in general to promotional advertising systems, and in particular, to the electronic purchase and redemption of promotions.

2. Description of Related Art

In today's competitive marketplace, businesses often use a form of promotional advertising to entice customers to purchase their goods or services in order to reduce inventory and/or increase market share by attracting new customers. For example, a business may offer a coupon for a discount on one or more items sold by the business. In order to receive the discount, the customer typically must either present a paper copy of the coupon when making purchases in person or mention the coupon (e.g., by providing a coupon code printed on the coupon) when making purchases over the phone or Internet.

Traditionally, coupons and other types of promotions have been distributed to customers through coupon books, mailed or hand-delivered advertisements (e.g., flyers, letters, postcards, etc.), newspapers, magazines, value packs and other forms of printed advertisements. Recently, businesses have begun to offer electronic coupons to customers that are either e-mailed to the customer or accessed by the customer through the business website or an on-line coupon distributor. However, redemption of electronic coupons still remains the same as redemption of paper coupons. The electronic coupons must be either printed off and presented to the business for in-person purchases or mentioned to the business (e.g., coupon code) for on-line or phone purchases.

Most customers find that clipping and organizing paper and printed electronic coupons is a difficult and time-consuming task. As a result, some customers would rather throw out paper coupons and delete electronic coupons than take advantage of any savings they may provide. Even for those customers that do save coupons, remembering and locating coupons prior to making purchases can be an even more time-consuming and difficult task. As a result, the majority of coupons either are discarded or expire before they can be redeemed.

Electronic coupons present even more problems for customers. For example, most customers do not have the time to search the Internet for the business that offers the best electronic coupon prior to making a purchase. In addition, customers may not want to open e-mails that contain electronic coupons due to spyware, cookies, computer viruses and other privacy concerns. Furthermore, the majority of customers are frustrated by pop-up advertisements, and therefore automatically delete and/or limit such pop-up advertisements. Therefore, businesses are not able to effectively target customers and/or maximize distribution and redemption of their promotions. Likewise, customers are not able to effectively obtain, manage and redeem promotions.

### SUMMARY OF THE INVENTION

Embodiments of the present invention provide a promotional advertising system and method for providing promotions to customers. The promotional advertising system includes a web server and a database for maintaining promotion information identifying one or more promotions offered by a business and customer information identifying customer credits for the promotions. The customer is provided a promotional card with a customer identifier thereon that uniquely identifies the customer to the promotional advertising system. When the customer presents the promotional card to the business, the business electronically accesses the customer information via the web server using the customer identifier on the promotional card to determine if the customer has any available customer credits for the business. If so, the business selects one of the customer credits to redeem the selected customer credit for the customer. The web server then deletes the selected customer credit from the customer information in the database.

### BRIEF DESCRIPTION OF THE DRAWINGS

A more complete understanding of the present invention may be obtained by reference to the following detailed description when taken in conjunction with the accompanying drawings wherein:

FIG. 1 is a block diagram of an exemplary promotional advertising system for providing promotions to customers, in accordance with embodiments of the present invention;

FIG. 2 is a flow chart illustrating an exemplary process for providing promotions to customers and enabling customers to redeem promotions, in accordance with embodiments of the present invention;

FIG. 3 illustrates an exemplary promotional advertising system for enabling a customer to subscribe thereto, in accordance with embodiments of the present invention;

FIGS. 4-6 are exemplary web pages illustrating on-line subscription to the promotional advertising system, in accordance with embodiments of the present invention;

FIG. 7 is an exemplary web page illustrating on-line viewing of customer information maintained by the promotional advertising system, in accordance with embodiments of the present invention;

FIG. 8 is an exemplary web page illustrating on-line viewing of administrative customer information, in accordance with embodiments of the present invention;

FIG. 9 is a flow chart illustrating an exemplary process for a customer to subscribe to the promotional advertising system, in accordance with embodiments of the present invention;

FIG. 10 illustrates an exemplary promotional advertising system for redeeming customer credits, in accordance with embodiments of the present invention;

FIGS. 11 and 12 are exemplary web pages illustrating redemption of customer credits by a business, in accordance with embodiments of the present invention;

FIG. 13 is an exemplary web page illustrating on-line viewing of business statistical information related to usage of the promotions, in accordance with embodiments of the present invention; and

FIG. 14 is a flow chart illustrating an exemplary process for redeeming a customer credit and updating business statistical information upon redemption of the customer credit, in accordance with embodiments of the present invention.

### DETAILED DESCRIPTION OF THE DRAWINGS

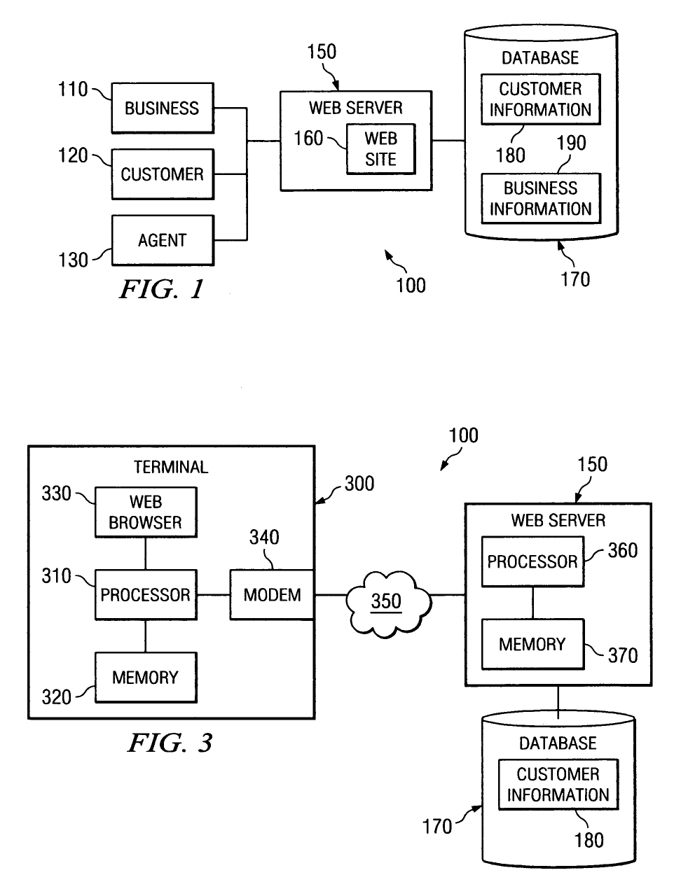

Referring to FIG. 1, there is illustrated an exemplary promotional advertising system 100 capable of implementing various embodiments of the present invention. The system 100 includes a web server 150 hosting a promotional advertising web site 160 and a database 170. The web site 160 provides a web interface to one or more businesses 110, customers 120 and agents 130 of the promotional advertising system 100 to enable businesses 110 and agents 130 to access and utilize the promotional advertising system 100 and customers 120 to access the promotional advertising system 100.

Each business 110 registers with the promotional advertising system 100 and provides to the promotional advertising system 100 business information 190 associated with the business 110. For example, business information 190 may include general information (e.g., business name, year founded, etc.), location information, detailed maps to business locations, hours of operation, occupancy, menus, sales prices for goods or services of the business 110, logos and advertising information for the business 110. In addition, the business information 190 may include promotion information identifying one or more promotions of the business 110 and business statistical information tracking the effectiveness of the promotions. For example, such business statistical information may include the number of promotions redeemed, the cost of the redeemed promotions and the added value obtained from the promotions.

As used herein, the term “promotion” includes anything offered by the business 110 or promotional advertising system 100 that furthers the acceptance and sale of goods or services of the business 110 through advertising, publicity, or discounting. By way of example, but not limitation, various promotions may include coupons for particular items, coupons for categories of items, coupons for free merchandise with the purchase of other merchandise, advertised sales, free gifts, money-back guarantees, group discounts, incentives and other special offers.

The types of promotions vary between businesses. For example, a restaurant may provide “Buy 1, Get 1 Free” promotions, a grocery store may provide a coupon for a particular item sold in the store, a movie theater may provide a promotion for free popcorn with the purchase of a drink, a fitness center may provide a promotion for a free trial period and a sporting event may provide a promotion for a group discount. In addition, promotions may expire and may vary between billing cycles. For example, a business 110 may provide one promotion during the month of May and another promotion during the month of June. Another business 110 may provide a promotion for “Buy 1, Get 1 Free” only from May to August and may offer each customer 120 only a certain number of the “Buy 1, Get 1 Free” promotions per billing cycle.

Thus, each business 110 coordinates with the promotional advertising system 100 to generate one or more web pages for the business 110. For example, one or more web pages may be accessible to potential customers 120 and/or existing customers 120 of the promotional advertising system 100 to advertise promotions and provide relevant information to customers 120, such as addresses of business locations, detailed maps to business locations, the hours of operation for each location, a list of goods or services available at each location and other information. Other web pages may be accessible only to employees of the business 110 to facilitate redemption of promotions by customers 120 and to manage the promotions by providing a web interface to the employees of the business 110. By way of example, but not limitation, one or more web pages may include tools to redeem promotions, track the cost of the promotions, track return customers, track customer spending habits, track inventory and determine the added value obtained from the promotions. The tools may include applications to perform the above-listed functionalities or applications to access the above-listed information.

Each customer 120 subscribes to the promotional advertising system 100 to obtain a membership to the promotional advertising system, and provides to the promotional advertising system 100 customer information 180 associated with the customer 120. For example, customer information 180 may include general information, such as the customer's name, mailing address, phone number, e-mail address and billing information (e.g., credit card information). The customer information 180 also includes customer credits for the promotions offered by the businesses 110 and savings information identifying either a potential amount of savings for the customer credits or an actual amount of savings for redeemed customer credits.

The customer credits are purchased by the customer 120 and are available to the customer 120 for the duration of a single billing cycle. For example, the billing cycle may be one month, three months, six months, one year or other period of time. The customer 120 may pre-pay for one or more billing cycles, and will receive new customer credits each billing cycle. Thus, at the end of a billing cycle, any unused customer credits are deleted from the customer's account, and a new set of customer credits is applied to the customer's account for the next pre-paid billing cycle. Updating customer credits each billing cycle enables businesses to control the number of promotions offered and redeemed.

Each customer credit is associated with a particular promotion offered by a particular business. Customer credits may be purchased for individual businesses or for groups of businesses. For example, a customer 120 may purchase customer credits for one or more categories of businesses and receive all promotions offered by the businesses within that category in a particular billing cycle for a flat rate. As an example, a customer 120 can purchase customer credits for the category of fast food restaurants, and receive customer credits (e.g., electronic coupons and other discounts) stored on the database 170 for the promotions offered by each of the fast food restaurants registered with the promotional advertising system 100 for a particular billing cycle.

Once a customer has subscribed to the promotional advertising system 100 and has purchased one or more customer credits, the web server 150 generates one or more web pages for the customer 120, which are accessible by the customer 120 through the web site 160. For example, one or more web pages may include tools to identify the particular businesses and/or categories of businesses to which the customer 120 has subscribed, identify the number of pre-paid billing cycles, identify the number and type of customer credits available for a particular business over a particular billing cycle and determine the potential and/or actual amount of savings for the customer credits.

For example, in one embodiment, the promotional advertising system 100 maintains an average savings amount for each promotion offered by the businesses 110, and calculates the amount of savings for a particular customer 120 using the average savings amounts for each promotion redeemed by the customer 120. In another embodiment, the business 110 provides purchase information indicating the actual price of each item purchased by a customer 120 to the promotional advertising system 100 when the customer 110 redeems a promotion. The promotional advertising system 100 uses the actual item prices to calculate the actual amount of savings for the customer 110.

Each agent 130 of the promotional advertising system 100 also has access to the customer information 180 and business information 190 via the web site 160. For example, an agent 130 may register a business 110, subscribe a customer 120, update business information 190 and/or customer information 180, view business information 190 and/or customer information 180, track customer visits to the website 160, track customer redemptions, maintain customer preferences, track customer savings, track business statistical information and access or manipulate any other information related to the promotional advertising system 100.

The database 170 stores the customer information 180 for each of the customers 120 and the business information 190 for each of the businesses 110. The web server 150 is in communication with the database 170 to populate the web pages of the website 160 with customer information 180 and/or business information 190 maintained by the database 170. In one embodiment, the database 170 is a robust database 170 that calculates in real-time the business statistical information and customer savings information. In another embodiment, the business statistical information and customer savings information is calculated by the web server 150 or off-line and merely stored in the database 170.

Each customer 120 is provided a membership card (hereinafter referred to as a promotional card) that includes a unique identifier for the customer 120. The unique customer identifier is used by the web server 150 to locate and retrieve the customer information 180 of the customer 120 in the database 170. In one embodiment, the customer 120 provides the customer identifier to the web server 170 to access web pages containing customer information 180. In another embodiment, the customer 120 presents this promotional card to a business 110, and the business 110 provides the customer identifier on the promotional card to the web server 150 to redeem customer credits for the customer.

For example, if a customer 120 has purchased a “Buy 1, Get 1 Free” customer credit for a particular restaurant, the customer 120 can present the promotional card to the restaurant to receive the “Buy 1, Get 1 Free” discount on his or her bill. The business 110 can access the website 160 and enter the customer's customer identifier to receive a web page that provides customer information 180 indicating whether the customer has any customer credits for the restaurant (i.e., whether the customer is entitled to a discount), and the type of customer credits available. To redeem an available customer credit, the business 110 selects (e.g., “clicks on”) one of the customer credits on the web page. Once a customer credit has been redeemed, the redeemed customer credit is deleted from the customer information 180 in the database 170.

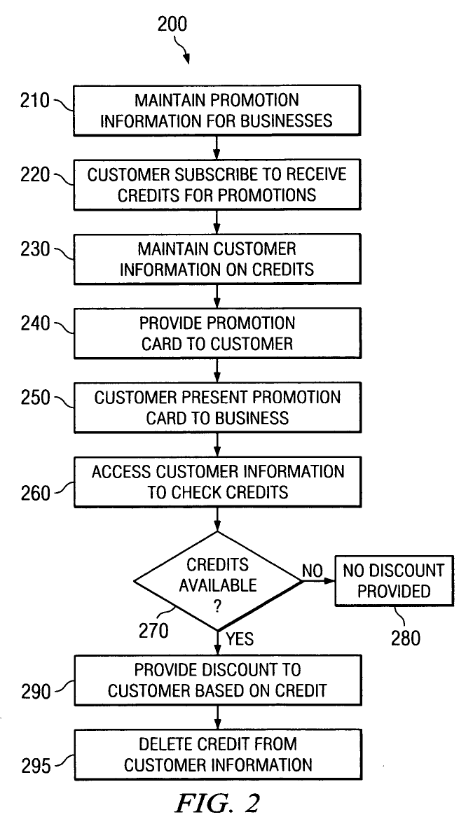

FIG. 2 is a flowchart illustrating an exemplary process 200 for providing promotions to customers and enabling customers to redeem promotions, in accordance with embodiments of the present invention. At block 210, promotion information identifying one or more promotions offered by one or more businesses is maintained by a promotional advertising system. At block 220, a customer subscribes to the promotional advertising system to receive customer credits for the promotions offered by the businesses. At block 230, the promotional advertising system maintains customer information identifying the customer credits purchased by the customer, and at block 240, once the customer becomes a member of the promotional advertising system, the customer is provided a promotional card that includes a unique identifier for the customer and is associated with the customer information.

When the customer desires to redeem one of the customer credits, at block 250, the customer presents the promotional card to a business, and at block 260, the business accesses the customer's credits using the customer identifier indicated on the promotional card to check the customer's credits for the business. The business can check the customer's credits via the Internet, phone or an automated voice service. For example, the business can either directly access the customer's credits via the Internet or call an agent or automated voice service of the promotional advertising system, which accesses the customer's credits. At block 270, a determination is made whether the customer has any available customer credits for the business (i.e., whether the customer is entitled to a discount at the business), and the type of customer credits available. If not (N branch of 270), the business does not provide a discount to the customer at block 280. If customer credits are available (Y branch of 270), at block 290, the business provides a discount to the customer based on the credit balance of the customer, and the promotional advertising system deletes the redeemed customer credit from the available credit balance in the customer information associated with the customer at block 295.

FIG. 3 illustrates an exemplary promotional advertising system 100 for enabling a customer to subscribe to the promotional advertising system 100, in accordance with embodiments of the present invention. The promotional advertising system 100 includes the web server 150, the database 170 and a terminal 300 associated with a customer. The terminal 300 is a physical communications device capable of sending and/or receiving communications over a communications network 350. Examples of such terminals 300 include, but are not limited to, a laptop computer, a personal computer, a cell phone and a personal digital assistant (PDA).

The terminal 300 further includes a processor 310, memory 320, web browser 330 and modem 340. The web browser 330 may be stored in memory 320, and is formed of computer-executable instructions, which when read and executed by the processor 310, causes the terminal 300 to connect to the World Wide Web via modem 340 and communication network 350. Based on customer instructions to the web browser 330, the modem 340 operates to connect the terminal 300 to the web server 150 via the communication network 350. In FIG. 2, the communication network 350 represents any type of network over which media (circuit-switched or packet-switched voice or data) may be sent. For example, the communication network 350 can include the Public Switched Telephone Network (PSTN), Public Land Mobile Network (PLMN), one or more private local area networks (LANs), the Internet and/or any other type or combination of networks.

The web server 150 includes a processor 360 and a memory 370. The processor 360 operates to generate and push web pages to the terminal 300 over the communication network 350. In one embodiment, the web pages are generated in real-time using web page templates and computer-executable instructions stored in memory 370. In another embodiment, the web pages are pre-generated and retrieved from memory 370 by the processor 360. The processor 360 further operates to receive customer input from the terminal 300 over the communication network 350 and to access the database 170 to store and retrieve customer information 180 associated with the customer. For example, in one embodiment, the processor 360 accesses the database 170 to retrieve customer information 180 associated with the customer and populates one or more web pages pushed to the terminal 300 with the retrieved customer information 180.

The processors 310 and 360 are generally understood to be any type of processing device, such as a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions stored in respective memories 320 and 370. The memories 320 and 370 are generally understood to be any type of storage device, such as a ZIP® drive, floppy disk, hard drive, CD-ROM, non-volatile memory device, tape, database or any other type of storage medium.

In operation, to subscribe a customer to the promotional advertising system 100, an agent of the promotional advertising system or the customer uses the terminal 300 to access the web server 150 of the promotional advertising system 100. The web server 150 pushes one or more web pages to the terminal 300 that provide a web interface to the promotional advertising system 100. For example, a web page may contain prompts for the agent or customer to enter customer information 180 for the customer, such as the customer's name, mailing address, phone number, e-mail address, billing information (e.g., credit card information) and selected categories of customer credits to receive promotions offered by the businesses registered with the promotional advertising system 100. The web server 150 stores the received customer information 180 in the database 170.

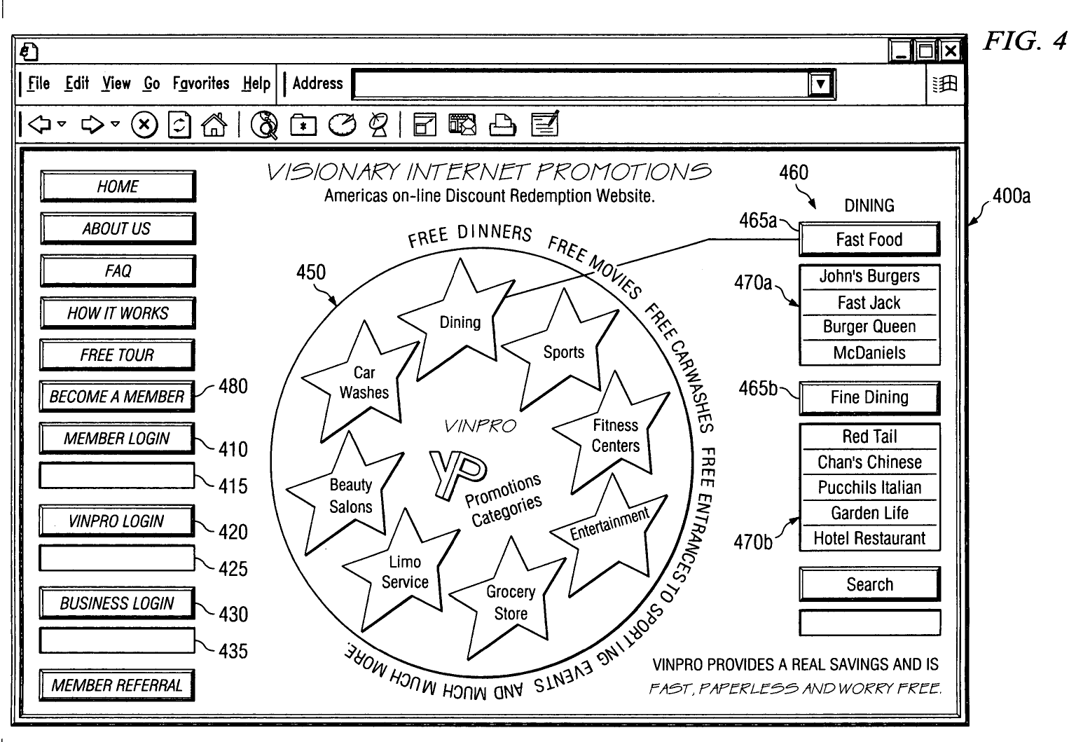

FIGS. 4-6 are exemplary web pages 400 illustrating on-line subscription to the promotional advertising system, in accordance with embodiments of the present invention. The web page shown in FIG. 4 represents an exemplary home web page 400a for the promotional advertising system. As can be seen in FIG. 4, the home web page 400a includes prompts 410, 420 and 430 requesting a user to log-in to the promotional advertising system as a customer (member), agent (VINPRO) or business, respectively. The web page 400a further includes windows 415, 425 and 435 for the user to enter their screen name and password as a customer, agent or business, respectively. The screen name and password are chosen by the user and associated with the user by the promotional advertising system. For example, a customer can log-in to the promotional advertising system using a screen name and password selected by the customer that is unique to the customer.

The home web page 400a further includes a window 450 displaying various promotions categories 460. Each promotion category 460 includes an individual business or multiple businesses related by industry, promotional type or other grouping factor. For example, as shown in FIG. 4, the category 460 of “Dining” includes two sub-categories, “Fast Food” 465a and “Fine Dining” 465b. Thus, if a user moves a cursor over the category 460 of “Dining,” the sub-categories 465a and 465b may appear on the web page 400a to enable the user to view more detailed information pertaining to the category 460 of “Dining.” In FIG. 4, the sub-category 465a of “Fast Food” includes a list 470a of businesses that sell “fast food” and are registered with the promotional advertising system to offer promotions to customers. Likewise, the sub-category 465b of “Fine Dining” includes a list 470b of businesses that sell “fine dining” and are registered with the promotional advertising system to offer promotions to customers. The customer can further search for a particular business to see if the business is registered with the promotional advertising system to offer promotions.

As a result, before a customer subscribes to the promotional advertising system, the customer can access one or more web pages that inform the customer of the categories and names of businesses that are participating in the promotional advertising system. In addition, the customer may be able to access additional web pages that advertise promotions and provide relevant information to customers on businesses participating in the promotional advertising system, such as addresses of business locations, detailed maps to business locations, the hours of operation for each location, a list of goods or services available at each location and other information. The customer can use this information when deciding whether to subscribe to the promotional advertising system.

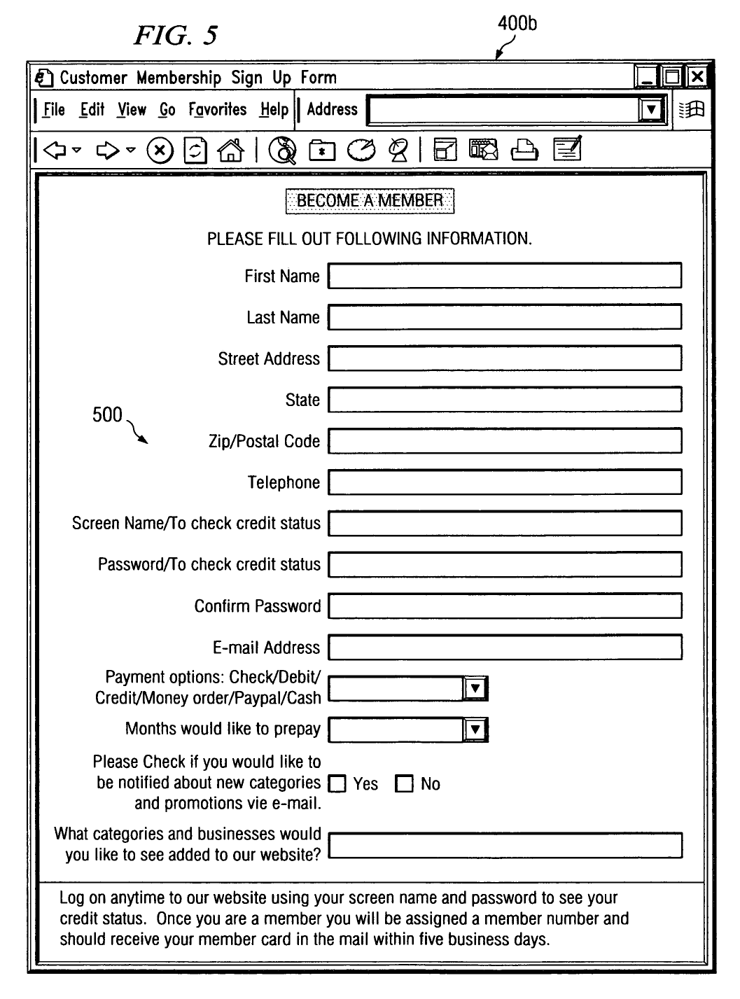

Referring now to FIG. 5, once the customer decides to subscribe to the promotional advertising system, the customer (or agent) can be provided with a subscription web page 400b containing prompts 500 for a customer to enter customer information, such as the customer's name, mailing address, phone number, e-mail address, billing information (e.g., credit card information), screen name and password to access the promotional advertising system (e.g., log-in information), whether the customer would like to pre-pay for one or more billing periods, whether the customer would like to be notified of new categories, promotions and businesses that are added to the promotional advertising system and whether the customer would like to have particular categories and/or businesses added to the promotional advertising system.

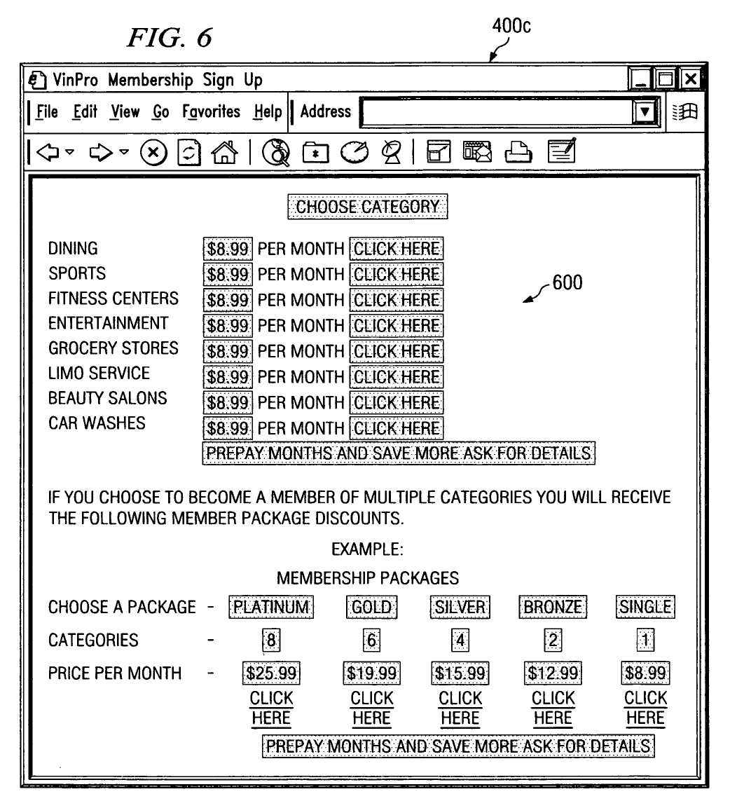

In addition to the subscription web page 400b, referring now to FIG. 6, the customer is also provided with a category web page 400c that allows the customer to select/purchase one or more promotions categories to receive customer credits for the selected categories. For example, the customer can purchase one or more categories of businesses and receive all promotions offered by the businesses within that category in a particular billing cycle for a flat rate.

As shown in FIG. 6, the category web page 400c provides the customer with selectable promotions category options 600 for the user to select from. For example, the customer may select one or more of the following promotions categories: “Dining,” “Sports,” “Fitness Centers,” “Entertainment,” “Grocery Stores,” “Limo Service,” “Beauty Salons,” and “Car Washes.” Each of the promotions categories is $8.99 per month. However, if the customer wants to purchase multiple categories, the category web page 400c further provides as part of the selectable promotions category options 600 packages of two or more categories for a reduced rate. For example, the customer can select the categories of “Dining” and “Entertainment” for the reduced rate of $12.99 per month for both categories to receive all coupons offered by all of the dining and entertainment businesses registered with the promotional advertising system.

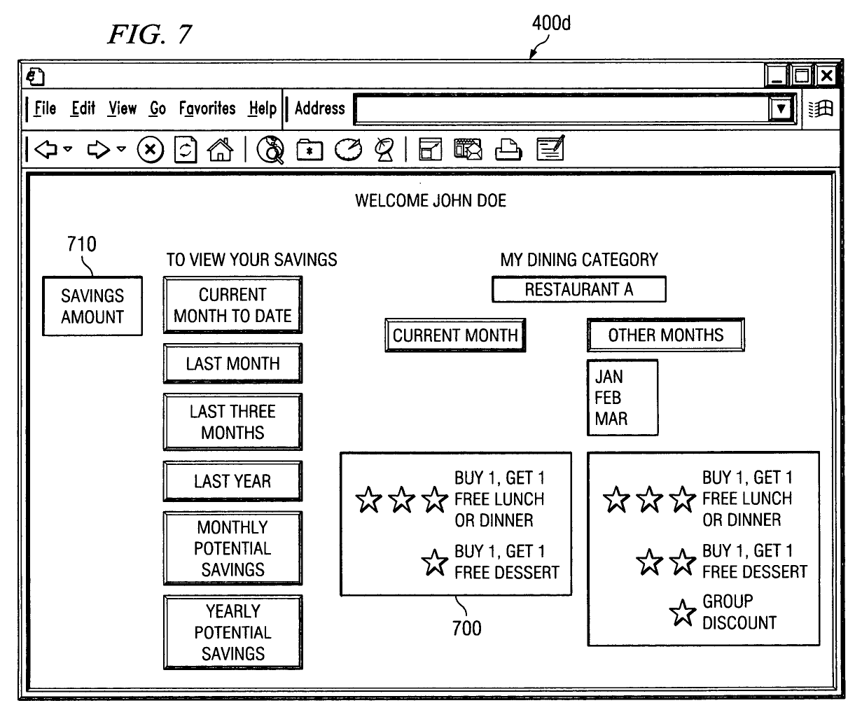

Once the customer has subscribed to one or more promotions categories, referring now to FIG. 7, the customer can access a customer web page 400d generated using customer information associated with the customer. For example, the customer can log-in to the web site, as shown in FIG. 4, using their screen name and password to view one or more of the customer web pages 400d. The customer web page 400d can display the user's name and/or the user's screen name and password.

In FIG. 7, the customer web page 400d for customer “John Doe” includes information identifying the particular businesses and/or categories of businesses to which the customer has subscribed, the number of pre-paid billing cycles and the number and type of customer credits available for a particular business over a particular billing cycle. For example, as shown in FIG. 7, the customer web page 400d for “John Doe” includes a customer credit window 700 that indicates that “John Doe” has three “Buy 1, Get 1 Free Lunch or Dinner” customer credits (shown as stars) and one “Buy 1, Get 1 Free Dessert” customer credit in the “Dining” promotions category available for the current month. The customer credit information can be displayed for all businesses in the “Dining” promotions category or for individually for each business in the “Dining” promotions category. Therefore, each business can control the number of customer credits offered to each customer.

The customer web page 400d may also include additional customer credit windows to inform the customer of the number and type of customer credits that the customer will have in future pre-paid months. In addition, the customer web page 400 may also indicate an expiration date for one or more businesses within the “Dining” promotions category. Thus, each business can designate an expiration date at which time the business will no longer offer one or more promotions to all customer or only to certain customers. Moreover, the business can control the number of customers allowed to receive the promotions. For example, a business can designate 100 customers to receive the promotions in the “Dining” category, and once the promotional advertising system has 100 customers subscribed to the “Dining” category, the business is removed from the “Dining” category for all subsequent customers.

The customer web page 400d further includes a savings amount window 710 identifying the potential and/or actual amount of savings for the customer credits. For example, as shown in FIG. 7, the customer web page 400d may present options to the customer to view the amount of savings for the current month-to-date, the previous month, the last three months, the past year or any other time period over which the customer may want savings information. As an example, if “John Doe” has redeemed one “Buy 1, Get 1 Free Dessert” customer credit during the current month, the amount the customer saved by using the “Buy 1, Get 1 Free Dessert” customer credit can be displayed in the savings amount window 710. This savings amount can be the actual amount the customer saved based on purchase information provided by the business or an average or estimated savings amount for the redeemed customer credit.

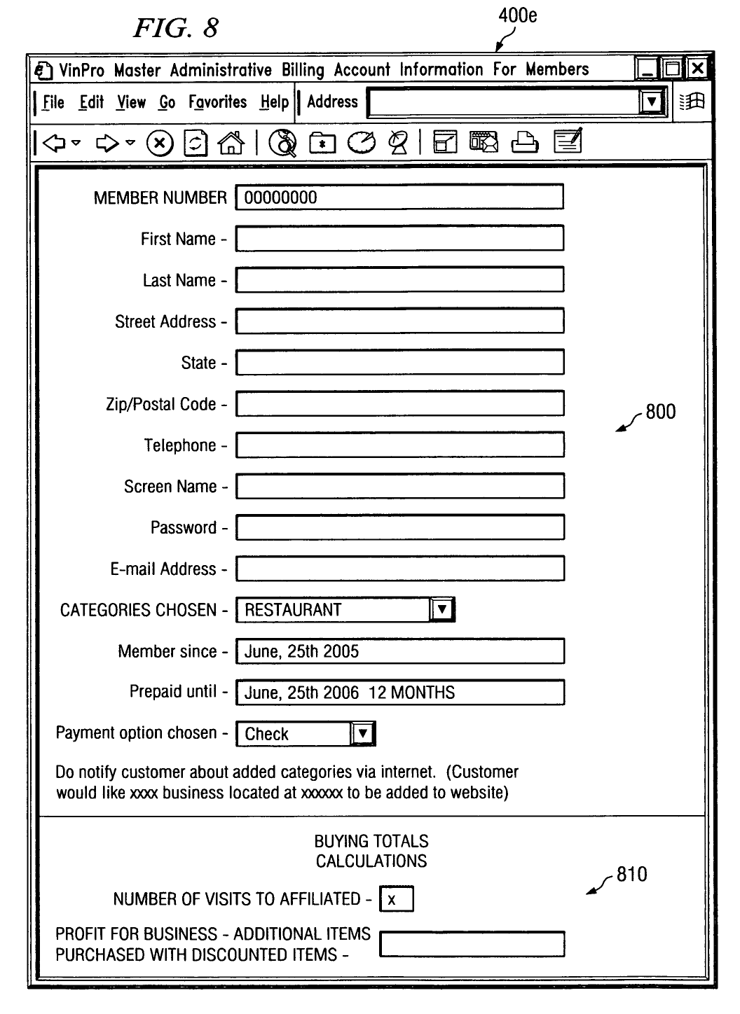

FIG. 8 is an exemplary web page 400e illustrating on-line entry and/or viewing of administrative customer information, in accordance with embodiments of the present invention. The administrative web page 400e includes prompts 800 for the agent of the promotional advertising system to enter and/or change customer information for a customer. The customer information may also indicate the promotions categories the customer has chosen, the date the customer subscribed to the promotional advertising system, payment information for the customer (e.g., pre-paid information and payment method) and customer preferences, such as whether the customer would like to be notified about added categories and the businesses the customer would like to be added to the promotional advertising system.

The administrative web page 400e may also include statistical information 810 for one or more customers and businesses. By way of example, but not limitation, such customer statistical information 810 may include the number of visits to one or more businesses registered with the promotional advertising system by a particular customer, the actual and/or potential savings for a particular customer, and business statistical information, such as the profit for a particular business due to additional items being purchased along with the discounted items.

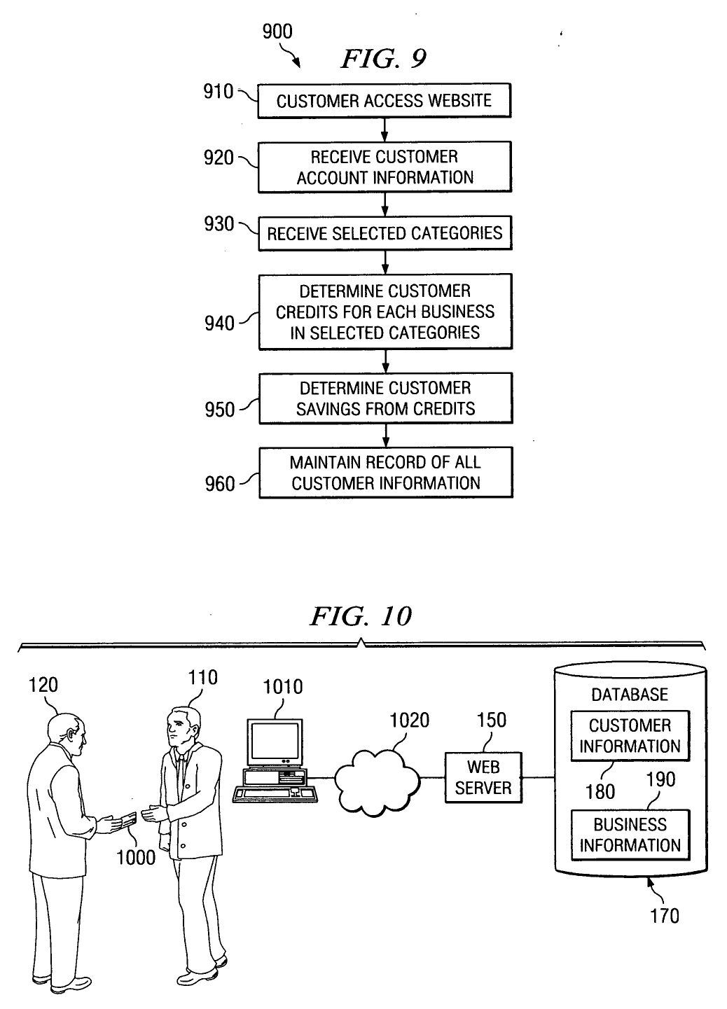

FIG. 9 is a flow chart illustrating an exemplary process 900 for a customer to subscribe to the promotional advertising system, in accordance with embodiments of the present invention. At block 910, the customer accesses the promotional advertising system website, either directly from a customer terminal or through an agent terminal of the promotional advertising system. At blocks 920 and 930, the promotional advertising system receives general customer account information associated with the customer and selected categories and/or businesses for which the customer would like to receive customer credits for promotions.

At block 940, the promotional advertising system determines the number and type of customer credits for each business in each selected category. At block 950, the promotional advertising system determines the actual and/or potential amount of savings that the customer receives from redeeming the assigned customer credits. Finally, at block 960, the promotional advertising system maintains a record of all the customer information, including the general customer account information, the selected categories, the number and type of customer credits for each business in each selected category, the number of redeemed customer credits for each business in each selected category and the actual and/or potential savings to the customer for redeeming the customer credits.

FIG. 10 illustrates an exemplary promotional advertising system for redeeming customer credits, in accordance with embodiments of the present invention. As mentioned above, when a customer 120 subscribes to the promotional advertising system, the customer 120 is provided a promotional card 1000 that includes a unique identifier for the customer 120. To redeem a customer credit at a business 110, the customer 120 presents his or her promotional card 1000 to an employee of the business 110. The employee of the business 110 accesses the web server 150 via a communication network 1020 using a terminal 1010 located at the business 110. By way of example, but not limitation, the terminal 1010 may be a laptop computer, personal computer, billing terminal, cash register terminal or other similar terminal.

The employee logs-in to the promotional advertising system (e.g., as shown in FIG. 4) by providing a screen name and password for the business 110. The web server 150 uses the screen name and password to retrieve business information 190 associated with the business 110 from the database 170. Once the business 110 is logged-in, the employee of the business 110 enters the customer identifier on the promotional card 1000 on the web page and transmits the customer identifier to the web server 150. In response, the web server retrieves the customer information 180 of the customer 110 that is pertinent to the business 110 and generates a web page that includes this pertinent customer information 180. For example, the pertinent customer information 180 may indicate whether the customer has any customer credits for the restaurant (i.e., whether the customer is entitled to a discount), and the type of customer credits available.

To redeem an available customer credit, the employee selects (e.g., “clicks on”) one of the customer credits on the web page. Once a customer credit has been redeemed, the redeemed customer credit is deleted from the customer information 180 in the database 170. The database 170 further maintains a log of the date of redemption, items purchased, customer savings, total value of the promotion and any added value for additional non-discounted purchased items.

In one embodiment, the business terminal 1010 includes a plug-in software application that interfaces with the web server 150, database 170 and a cash register software application (or other similar application) used by the business 110 to calculate the customer's bill to provide purchase information identifying the items purchased and the associated purchase prices to the web server 150. In another embodiment, the business terminal 1010 includes a conventional web browser for interfacing with the web server 150, and the web server 150 maintains the billing software needed to generate a bill for the customer.

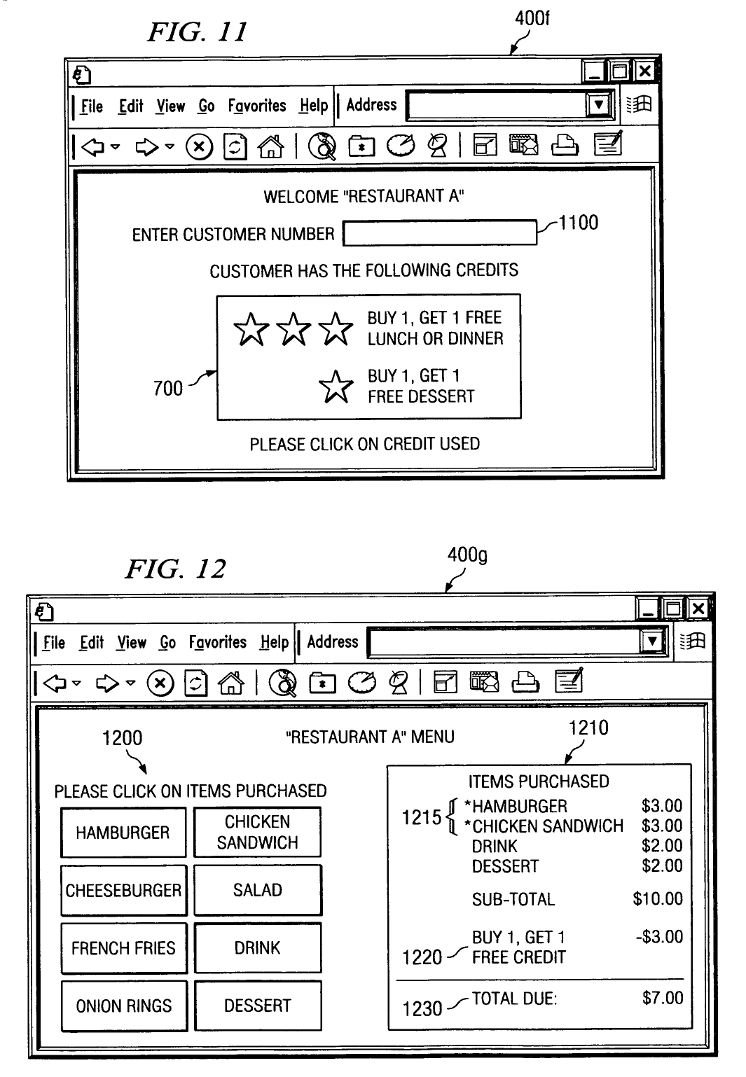

FIGS. 11 and 12 are exemplary web pages illustrating redemption of customer credits by a business, in accordance with embodiments of the present invention. In FIGS. 11 and 12, the business is called “Restaurant A.” Once “Restaurant A” has logged-in to the promotional advertising system, the web server generates and pushes a customer credit web page 400f to the business that provides a prompt for the business to enter the customer number of the customer redeeming a customer credit at the business in a window 1100. After the business has entered the customer number, the web server accesses the database to determine the number and type of customer credits that are available to the customer for “Restaurant A.” In the example shown in FIG. 11, the customer credit web page 400f includes the customer credit window 700 that indicates that the customer has three “Buy 1, Get 1 Free Lunch or Dinner” customer credits (shown as stars) and one “Buy 1, Get 1 Free Dessert” customer credit available to use at “Restaurant A” during the current month. Additional customer credits may include a “money-back guarantee” offered by the promotional advertising system for a particular category that enables a customer to receive a free lunch or dinner at any restaurant in the “Dining” category so that the customer can recoup the money spent for the membership to the “Dining” category.

To redeem one of the available customer credits, the employee selects (e.g., “clicks on”) one of the customer credits on the customer credit web page 400f. Once the employee has selected a particular customer credit for redemption, in an exemplary embodiment, as shown in FIG. 12, the web server generates and pushes a bill web page 400g to the business from which the employee can generate a customer bill. For example, the business can provide a menu to the promotional advertising system, which is either stored in the database or uploaded to the web server when the business logs-in to the web server. The bill web page 400g presents selectable menu options 1200, each representing an item found on the menu of “Restaurant A.” The employee of the business selects (“clicks on”) those menu options 1200 corresponding to items purchased by the customer. The bill web page 400g further includes a bill window 1210 that itemizes the selected menu options 1200 and calculates the bill for the customer.

For example, as shown in FIG. 12, the employee selected the following menu items: “Hamburger,” “Chicken Sandwich,” “Drink” and “Dessert.” The bill window 1210 displays each of these menu items purchased by the customer, the price of each item and the sub-total for the purchased menu items. The bill window 1210 further displays the customer credit 1220 selected by the employee in the customer credit web page 400f shown in FIG. 11, the discount associated with the selected customer credit 1220 and the total amount due 1230 after the discount.

For example, as shown in FIG. 12, the selected customer credit 1220 is “Buy 1, Get 1 Free Lunch or Dinner Item.” The promotional advertising system takes as input the selected/purchased items and the selected customer credit 1220 to determine the items that qualify for the selected customer credit 1220. In FIG. 12, the two items purchased by the customer that qualify for the selected customer credit 1220 are the “Hamburger” and the “Chicken Sandwich.” Since the redeemed customer credit is “Buy 1, Get 1 Free,” and the price of the “Hamburger” and the “Chicken Sandwich” are both $3.00, the discount calculated by the promotional advertising system is $3.00. The bill web page 400g may then interface with a cash register application (or similar application) to generate a bill that can be printed from the business terminal and presented to the customer for payment.

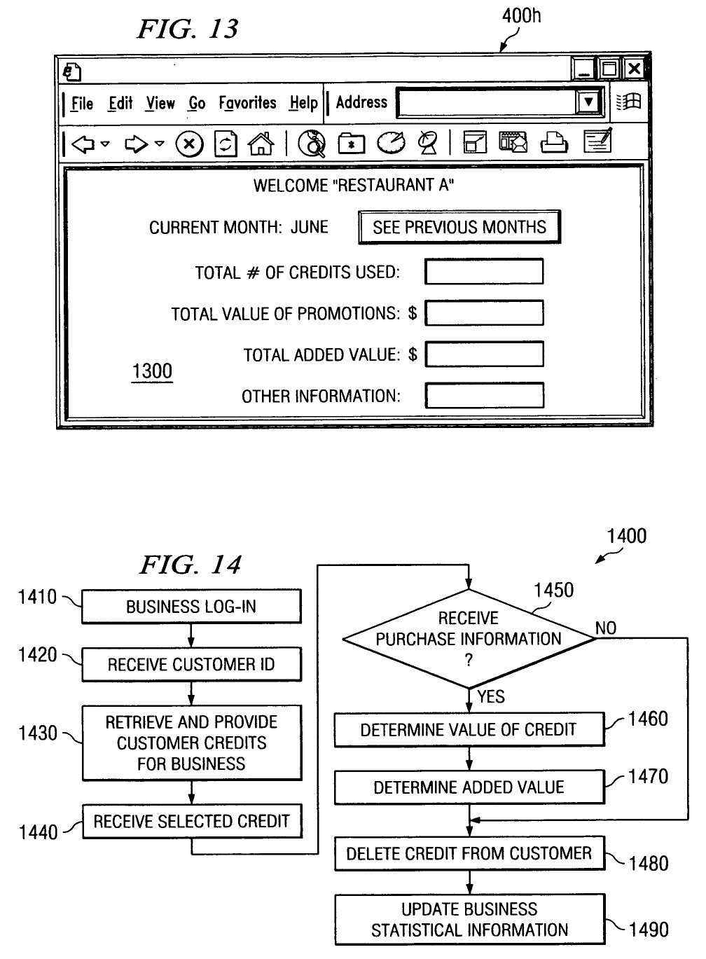

FIG. 13 is an exemplary web page illustrating on-line viewing of business statistical information related to usage of the promotions, in accordance with embodiments of the present invention. Once the business has registered with the promotional advertising system, the business can access a business web page 400h generated using business information associated with the business. For example, the business can log-in to the web site, as shown in FIG. 4, using their screen name and password to view one or more of the business web pages 400h.

In FIG. 13, the business web page 400h for “Restaurant A” includes business statistical information 1300 identifying various business calculations for the business. For example, the business statistical information 1300 shown in FIG. 13 includes the total number of customer credits used (redeemed) by one or more customers in the current month (e.g., the total number of visits by a particular customer or the total number of visits by all customers), the total value of the promotions redeemed in the current month (e.g., the monetary amount of the promotional items or the monetary amount given away for promotional purposes), the total added value of extra items (non-discounted) purchased by customers who redeemed promotions in the current month and other business statistical information. For example, using the selected menu items shown in FIG. 12, the total value of the promotion redeemed in FIG. 12 is $3.00 and the total added value of non-discounted items is $4.00 for the “Drink” and “Dessert” purchased by the customer. The business web page 400h may also display similar business statistical information for other time periods of interest.

FIG. 14 is a flow chart illustrating an exemplary process 1400 for redeeming a customer credit and updating business statistical information upon redemption of the customer credit, in accordance with embodiments of the present invention. At block 1410, a business logs-in to the promotional advertising system, and at block 1420, the promotional advertising system receives a customer identifier of a customer that is redeeming a customer credit at the business. Using the customer identifier, at block 1430, the promotional advertising system retrieves the available customer credits associated with the customer for the business and provides the available customer credits to the business. At block 1440, the promotional advertising system receives a selected customer credit from the business to redeem.

At block 1450, a determination is made whether the business also provides purchase information indicating the purchase prices of items purchased by the customer while redeeming the customer credit. If purchase information is not provided (N branch of 1450), at block 1480, the redeemed customer credit is deleted from the credit balance in the customer information, and at block 1490, the promotional advertising system updates any business statistical information associated with the business. For example, the promotional advertising system can increase the number of redeemed promotions for the business. If purchase information is provided (Y branch of 1450), at blocks 1460 and 1470, the promotional advertising system determines the value of the redeemed customer credit and any added value from additional non-discounted items purchased by the customer, and updates the business statistical information using the redeemed value and added value.

As will be recognized by those skilled in the art, the innovative concepts described in the present application can be modified and varied over a wide rage of applications. Accordingly, the scope of patents subject matter should not be limited to any of the specific exemplary teachings discussed, but is instead defined by the following claims.

I claim:

1. A method for providing electronic promotions to customers, comprising the steps of:
maintaining promotion information for a business, said promotion information identifying one or more promotions offered by said business;
maintaining customer information for a customer, said customer information identifying customer credits for said one or more promotions, said customer information having a customer identifier associated therewith;
electronically accessing said customer information using said customer identifier provided by said customer on a promotional card to determine said customer credits for said business;
selecting a select one of said customer credits to redeem said select customer credit for said customer and provide said promotion associated with said select customer credit to said customer; and
deleting said select customer credit from said customer information.

2. The method of claim 1, further comprising the step of:
electronically subscribing said customer to one or more promotional categories, each of said promotional categories including one or more businesses and each of said one or more businesses having respective business information identifying promotions associated therewith.

3. The method of claim 2, wherein said step of electronically subscribing further comprises the step of:
electronically subscribing said customer to said one or more promotional categories for one or more billing cycles.

4. The method of claim 3, wherein said promotions offered by said one or more businesses are updated each of said billing cycles.

5. The method of claim 4, further comprising the step of:
enabling said customer to view said promotions available for each of said billing cycles via a web interface.

6. The method of claim 5, further comprising the steps of:
determining savings information associated with said customer credits, said savings information identifying at least one of a potential amount of savings for said customer credits or an actual amount of savings for redeemed ones of said customer credits; and
enabling said customer to view said savings information for one or more of said billing cycles via said web interface.

7. The method of claim 1, wherein said electronically accessing said customer information further comprises the steps of:
logging-in said business using a business identifier;
receiving said customer identifier from said business;
retrieving said customer credits associated with said customer identifier for said business;
providing said customer credits to said business; and
receiving said select customer credit from said business.

8. The method of claim 1, further comprising the step of:
updating business statistical information for said business using said select customer credit; and
enabling said business to view said business statistical information via a web interface.

9. The method of claim 8, further comprising the steps of:
receiving purchase information from said business related to said select customer credit, said purchase information identifying one or more items purchased by said customer;
determining a credit cost of said select customer credit from said purchase information;
determining an added value associated with said select customer credit from said purchase information; and
updating said business statistical information using said credit cost and said added value.

10. The method of claim 9, further comprising the step of:
calculating a bill for said items purchased by said customer using said purchase information and said select customer credit.

11. A promotional advertising system for providing electronic promotions to customers, comprising:
a database configured to maintain promotion information for a business, said promotion information identifying one or more promotions offered by said business and to maintain customer information for a customer, said customer information identifying customer credits for said one or more promotions, said customer information having a customer identifier associated therewith; and
a web server operable to access said customer information in said database using said customer identifier provided by said customer on a promotional card to said business to determine said customer credits for said business;
wherein said web server is further operable to select a select one of said customer credits to enable said business to redeem said select customer credit for said customer and provide said promotion associated with said select customer credit to said customer;
wherein said web server is further operable to delete said select customer credit from said customer information.

12. The system of claim 11, wherein said web server is further operable to receive a request from said customer to subscribe to one or more promotional categories, each of said promotional categories including one or more businesses and each of said one or more businesses having respective business information identifying promotions associated therewith.

13. The system of claim 12, wherein said web server is further operable to subscribe said customer to said one or more promotional categories for one or more billing cycles.

14. The system of claim 13, wherein said web server is further operable to update said business information for each of said businesses in said database each of said billing cycles.

15. The system of claim 14, wherein said web server is further operable to provide a web interface to said customer to enable said customer to view said promotions available for each of said billing cycles.

16. The system of claim 15, further comprising:
a processor operable to determine savings information associated with said customer credits, said savings information identifying at least one of a potential amount of savings for said customer credits or an actual amount of savings for redeemed ones of said customer credits; and
wherein said web server is further operable to enable said customer to view said savings information for one or more of said billing cycles via said web interface.

17. The system of claim 11, wherein said web server is further operable to receive a business identifier from said business to log-in said business, receive said customer identifier from said business, retrieve said customer credits associated with said customer identifier for said business from said database, provide said customer credits to said business via a web interface and receive said select customer credit from said business.

18. The system of claim 11, further comprising:
a processor operable to update business statistical information for said business using said select customer credit; and
wherein said web server is further operable to enable said business to view said business statistical information via a web interface.

19. The system of claim 18, wherein said web server is further operable to receive purchase information from said business related to said select customer credit, said purchase information identifying one or more items purchased by said customer; and wherein said processor is further operable to determine a credit cost of said select customer credit from said purchase information, determine an added value associated with said select customer credit from said purchase information and update said business statistical information using said credit cost and said added value.

20. The system of claim 19, wherein said web server is further operable to calculate a bill for said items purchased by said customer using said purchase information and said select customer credit.
